(19) United States
(12) Patent Application Publication
(10) Pub. No.: US 2026/0213837 A1
(43) Pub. Date: Jul. 23, 2026

(54) APPARATUS, SYSTEM AND METHOD FOR TESTING A FIBER OPTIC NETWORK

(71) Applicant: British Telecommunications Public Limited Company, London (GB)

(72) Inventors: Lauren FLEMING, London (GB); Neil PARKIN, London (GB)

(21) Appl. No.: 19/139,743

(22) PCT Filed: Nov. 9, 2023
(86) PCT No.: PCT/EP2023/081286

§ 371 Date: Jun. 16, 2025

(30) Foreign Application Priority Data
Dec. 16, 2022 (EP) 22214274.7

(51) Int. Cl. H04B 10/071; G01M 11/00

(52) U.S. Cl. CPC H04B 10/071; G01M 11/3109

(57) ABSTRACT

A system for testing a fibre optic network (100), comprising:an apparatus (110) comprising: a reflective element (210) for intercepting a light transmission transmitted along a fibre optic cable (160) of the fibre optic network, the reflective element having a parameter-based variable reflectivity response (300); and an adjustor (220) for adjusting the parameter associated with the reflective element, thereby to change, at a given wavelength of the light transmission, reflectivity of the reflective element thereby selectively to change between a first reflectivity and a second reflectivity; an optical source (130) for transmitting the light transmission through the fibre optic cable to the reflective element; and an optical reflectometry sensor (130) for detecting a reflection of the light transmission through the fibre optic cable from the reflective element.

### PRIORITY CLAIM

The present application is a National Phase entry of PCT Application No. PCT/EP2023/081286, filed Nov. 9, 2023, which claims priority from EP Application No. 22214274.7 filed Dec. 16, 2022, each of which hereby fully incorporated herein by reference.

### TECHNICAL FIELD

The present disclosure relates to an apparatus, a system and a method for testing a fiber optic network, and in particular by exploiting a parameter-controlled dependent reflectivity response of a reflective element installed within the fiber optic network.

### BACKGROUND

Large-scale fiber optic networks, as used in wide-area fixed-access telecommunications, are complex, and the infrastructure required to establish such networks may be difficult to access. As a result, such networks can be difficult to monitor and audit. In turn, identifying and locating individual network features (e.g. fiber optic cables, connectors, splitters, switches, filters and other components, as well as faults) may be a considerable challenge.

An Optical Time Domain Reflectometer (OTDR) is a diagnostic device used in fiber optic networks that injects an optical pulse (or a diagnostic signal) and measures the arrival time of (and, by inference, the distance travelled by) light reflected as a result of Fresnel back-reflections and Rayleigh backscatter from fiber optic cables and reflections from connectors and other discontinuities in the network. A resultant OTDR trace is produced in which features, and their state, can be identified from characteristics of detected reflections.

However, interpreting an OTDR trace presents challenges, and such traces can have limited real-world efficacy. Typically, an OTDR trace is manually interpreted by trained engineers who tag identified features. However, an OTDR trace may contain a large number of reflections (often, at least thirty), and manual analysis can therefore be time-consuming. Furthermore, co-located features (especially downstream of splitters in a Passive Optical Network) may not be distinguishable in OTDR traces, and therefore cannot be individually discerned for identification. Yet further, physically locating a sought network feature using distances calculated from an OTDR trace may also be difficult since fiber optics cables may have slack and small deviations, and also because the accuracy of calculating distances requires accurate knowledge of refractive indices, which may unknowingly vary with temperature and media. As a result, interpreting OTDR traces can be labor-and resource-intensive, and may also be error-prone or lead to conclusions that do not correspond with the actual physical network.

In sum, network analysis using an OTDR can be inefficient and be prone to misidentification and/or misreporting of features in the fiber optic network, which in turn may cause ineffective operation and maintenance of the fiber optic network.

### SUMMARY

It is an aim of the present disclosure at least to alleviate some of the aforementioned problems.

According to a first aspect of the present disclosure, there is provided: an apparatus for use in testing a fiber optic network, comprising: a reflective element for intercepting a light transmission transmitted along a fiber optic cable of the fiber optic network, the reflective element having a parameter-based variable reflectivity response; and an adjustor for adjusting the parameter associated with the reflective element, thereby to change, at a wavelength of the light transmission, reflectivity of the reflective element thereby selectively to change between a first reflectivity and a second reflectivity.

Optionally, the reflective element is further configured to have a wavelength-dependent variable reflectivity response. Optionally, the first reflectivity and the second reflectivity are the same or are different. Optionally, the second reflectivity is less than the first reflectivity, or vice versa. In some embodiments, at the wavelength, the second reflectivity is at most 95%, such as at most 50%, at most 25%, or at most 10%, of the first reflectivity. Optionally, at the wavelength, the first reflectivity is mostly reflective and wherein the second reflectivity is mostly transparent.

Optionally, the first reflectivity is a peak or maximal reflectivity of the reflective element. Optionally, the first reflectivity is achieved without using, operating or actuating the adjustor, and may therefore be a default reflectivity of the reflective element when the adjustor and/or the reflective element is/are in a default or ambient state. In some embodiments, the light transmission has a known wavelength. In some embodiments, the adjustor is non-destructive to the reflective element. In some embodiments, the reflective element is configured, when switching between the first and the second reflectivity, to remain exposed to intercept the light transmission; that is, the first and second reflectivity are not governed by obstruction or obscuring of the reflective element. In some embodiments, the parameter-based reflectivity response, at a wavelength, is continuous, rather than binary or discrete.

In some embodiments, the parameter is temperature, and wherein the adjustor is a heater and/or a cooler configured to change a temperature of the reflective element. Optionally, the heater and/or cooler is a Peltier heat pump, and may be a one-, two-, three-, or four-stage thermoelectric heat pump.

Optionally, the heater and/or cooler is configured to achieve a temperature change of at least 50 degrees Centigrade, such as at least 100 degrees Centigrade, or at least 200 degrees Centigrade. Optionally, the second reflectivity is achieved at a higher temperature than the first reflectivity, or vice versa.

Optionally, the fiber optic cable comprises a thermal conductor thermally coupled to reflective element and/or the heater and/or cooler. In some embodiments, the apparatus further comprises a thermal insulator for insulating the reflective element and/or the adjustor from a surrounding environment.

In some embodiments, at the wavelength, the first reflectivity is achieved at an ambient temperature, wherein said ambient temperature is between −20 and 40 degrees Centigrade, such as between −10 and 30 degrees Centigrade, or between 0 and 20 degrees Centigrade.

In some embodiments, the reflective element returns to the first reflectivity from the second reflectivity by cooling by passive cooling, or vice versa.

In some embodiments, the parameter is an angle of the reflective element relative to the light transmission, and wherein the adjustor is a mechanism for orientating (or re-orientating) the reflective element relative to the light transmission. Optionally, the second reflectivity is achieved at a greater angle than the first reflectivity, or vice versa. Optionally, the adjustor is an actuator, or a hinged or rotatable element.

In some embodiments, the parameter is a physical form of the reflective element, and wherein the adjustor is a mechanism for changing a form of (or deforming) the reflective element. In some embodiments, the deforming is induced by applying a mechanical stress, wherein said stress may be: tension; compression; shear; bending and/or torsion.

In some embodiments, the parameter is an electric field, current or voltage to which the reflective element is exposed, and wherein the adjustor is an electric circuit therefor. Optionally, the reflective element exhibits electro-reflective properties.

In some embodiments, the reflective element is provided within the fiber optic cable. Optionally, the reflective element is integrally formed as a part of the fiber optic cable, and may be formed as a part of a core of said cable. Optionally, the fiber optic cable, or a portion thereof (such as an outer jacket and/or strength member) is thinner where the reflective element is provided than at a proximate region of the fiber optic cable, thereby to help improve heat transfer to/from, stress and/or actuation of the reflective element.

In some embodiments, the apparatus further comprising an optical connector for connecting the reflective element to the fiber optic cable, thereby to intercept and reflect the light transmission. In some embodiments, the optical connector is configured to arrange the reflective element in-line with the fiber optic cable. In some embodiments, the optical connector is a or an end-connector Optionally, the optical connector comprises a filter. Optionally, the apparatus is formed as a part of a/an: splitter; through-connector; end reflector; Optical Network Terminal; coupler; and/or Wavelength-Division Multiplexer.

In some embodiments, the reflective element comprises an optical grating. In some embodiments, the grating is a Bragg grating, such as a fiber Bragg grating. Optionally, the reflective element comprises a retroreflector, dielectric mirror and/or a thin-film reflector. In some embodiments, where the adjustor is a heater and/or cooler, the grating is configured to expand with temperature, thereby to increase a period of the grating. Optionally, the reflective element exhibits piezoelectric properties, and wherein a period of the optical grating is adjustable by the electric circuit as a result of the piezoelectric properties.

In some embodiments, the light transmission is a diagnostic test signal. In some embodiments, the wavelength is within the U-band or C-band, as defined by the ITU Telecommunication Standardization Sector. In some embodiments, the wavelength is between 1500 nm and 1700 nm, such as between 1625 nm and 1675 nm, or between 1535 nm and 1565 nm. In some embodiments, the diagnostic test signal, or pulse, does not carry signals for providing a telecommunications service to a user, and is therefore merely for testing and diagnostics.

In some embodiments, the first reflectivity and/or the second reflectivity is/are substantially transparent to a service signal transmitted at a service wavelength. In some embodiments, the service signal is used to communicate a telecommunications service to a user. Optionally, the service wavelength is less than 1625 nm and/or more than 1700 nm.

In some embodiments, the apparatus further comprises a sensor for detecting a state of the adjustor and/or for measuring the parameter as associated with the reflective element. Optionally, the sensor is a temperature, position, current, electric field, voltage, form, shape, orientation, pressure, and/or force sensor. In some embodiments, the apparatus further comprises a receiver for receiving a transmitted instruction for controlling the adjustor, and in particular to operate the adjustor so as to achieve the first reflectivity and/or the second reflectivity. Optionally, the receiver is in communication with an Optical Test Head, OTH, of the fiber optic network (e.g. the optical source and/or optical reflectometry sensor), and from which the transmitted instruction may be transmitted to the receiver. In some embodiments, the apparatus further comprises a transmitter for remotely communicating data from the sensor, wherein said data may be communicated to the OTH.

According to another aspect of the disclosure, there is provided a system for testing a fiber optic network, comprising: an apparatus comprising: a reflective element for intercepting a light transmission transmitted along a fiber optic cable of the fiber optic network, the reflective element having a parameter-based variable reflectivity response; and an adjustor for adjusting the parameter associated with the reflective element, thereby to change, at a wavelength of the light transmission, reflectivity of the reflective element thereby selectively to change between a first reflectivity and a second reflectivity; an optical source for transmitting the light transmission through the fiber optic cable to the reflective element; and an optical reflectometry sensor for detecting a reflection of the light transmission through the fiber optic cable from the reflective element.

In some embodiments, the apparatus is provided away from the optical source and the optical reflectometry sensor.

In some embodiments, the apparatus is arranged at, or proximate to, an Optical Network Terminal (ONT), Connectorized Block Terminal (CBT), or a splitter of the fiber optic network.

In some embodiments, the optical source and/or the optical reflectometry sensor form/s part of an Optical Time-Domain Reflectivity apparatus. In some embodiments, the wavelength of the light transmission is constant. In some embodiments, the optical source is a telecommunications service, and/or a testing and diagnostics, signal generator and transmitter.

In some embodiments, the optical source and/or the optical reflectometry sensor form/s part of an Optical Frequency-Domain Reflectivity apparatus. In some embodiments, the wavelength of the light transmission is variable in a known way, and wherein the first reflectivity and the second reflectivity are substantially identical at respective different wavelengths of the light transmission. That is, the adjustor may be operated to maintain constant reflectivity with the varying wavelength of the light transmission. To do so, the adjustor and the optical source may be in communication with one another so as to synchronize wavelength and a targeted constant first reflectivity and second reflectivity. In some embodiments, the transmitter is configured to communicate data from the sensor to the OTH, in response to which the OTH is configured to transmit the instruction for controlling the adjustor, thereby to instruct the adjustor to adjust the parameter associated with the reflective element so as to achieve the first reflectivity and/or second reflectivity.

In some embodiments, the fiber optic network is in the form of a point-to-multipoint Passive Optical Network (PON).

According to yet another aspect of the disclosure, there is provided a method of testing a fiber optic network, the network comprising: an apparatus comprising: a reflective element for intercepting a light transmission transmitted along a fiber optic cable of the fiber optic network, the reflective element having a parameter-based variable reflectivity response; and an adjustor for adjusting the parameter associated with the reflective element, thereby to change, at a wavelength of the light transmission, reflectivity of the reflective element thereby selectively to change between a first reflectivity and a second reflectivity; an optical source for transmitting the light transmission through the fiber optic cable to the reflective element; and an optical reflectometry sensor for detecting a reflection of the light transmission through the fiber optic cable from the reflective element. the method comprising: retrieving, from the optical reflectometry sensor: a first reflection result for a first test performed using the light transmission transmitted by the optical source through the fiber optic cable to the reflective element whilst the reflective element is configured to have the first reflectivity; and a second reflection result for a second test performed using the light transmission transmitted by the optical source through the fiber optic cable to the reflective element whilst the reflective element is configured to have the second reflectivity, as achieved by using the adjustor; comparing the first and the second reflection results; identifying an expected change between the first and the second reflection results, as a consequence of switching or changing between the first reflectivity and the second reflectivity; and locating the reflective element on the first and/or second reflection result/s where the expected change is identified.

Optionally, the identifying and/or locating is/are computer-implemented. Optionally, the first test is performed without activating or operating the adjustor, and/or wherein the second test is performed having activated or operated the adjustor. Optionally, the locating (or identifying) the reflective element comprises marking, tagging and/or associating data in the first and/or second reflection result/s as or with the reflective element. In some embodiments, the parameter-and/or wavelength-dependent reflectivity response of the reflective element is known and predictable, which may be achieved through prior calibration, testing and/or configuration of the apparatus. In some embodiments, the second reflectivity is achieved by targeting a change in the parameter to a value determined according to the known parameter-and/or wavelength-dependent reflectivity response. In some embodiments, the expected change is derived from the known parameter-and/or wavelength-dependent reflectivity response and/or the targeted change in the parameter value; that is the change may have been predicted, rather than being an anomaly or a fault. In some embodiments, the method further comprises performing the first and second tests.

Optionally, the second test is performed in response to determining that the adjustor has achieved the targeted change in the parameter value. So as to help improve accuracy, and in particular confidence in the causal relationship between changing between the first and second reflectivity and the expected change, the method can further comprise reiterating the afore-described method, which may be re-iterated at a pre-determined and known frequency.

The first and second reflections may be retrieved in any order and/or the first and second tests may be, or have been, performed in any order. Optionally, the retrieving is performed by an Optical Test Head of the fiber optic network.

In some embodiments, expected change is an expected attenuation. In some embodiments, the expected attenuation is at least 75%, such as at least 90%, or at least 95%.

In some embodiments, the optical reflectometry sensor is an Optical Time-Domain Reflectometer. In some embodiments, the optical reflectometry sensor is an Optical Frequency-Domain Reflectometer (OFDR); the first reflectivity and the second reflectivity are equal; the adjustor is operated to maintain a constant reflectivity; and the expected change is therefore an expected constancy.

In some embodiments, a time period between the first test and the second test is known, and wherein the adjustor is operated to switch between the first reflectivity and the second reflectivity with a frequency equal, or corresponding to, said known period. In some embodiments, the adjustor is remotely operated by the optical source and/or the optical reflectometry sensor.

According to a still further aspect of the disclosure, there is provided a computer-readable carrier medium comprising a computer program, which, when the computer program is executed by a computer, causes the computer to carry out a method as described above.

The disclosure includes any novel aspects described and/or illustrated herein. The disclosure also extends to methods and/or apparatus substantially as herein described and/or as illustrated with reference to the accompanying drawings. The disclosure 000000 is also provided as a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

Any apparatus feature may also be provided as a corresponding aspect of a method, and vice versa. As used herein, means plus function features may alternatively be expressed in terms of their corresponding structure, for example as a suitably-programmed processor.

Any feature in one aspect of the disclosure may be applied, in any appropriate combination, to other aspects of the disclosure. Any, some and/or all features in one aspect can be applied to any, some and/or all features in any other aspect, in any appropriate combination. Particular combinations of the various features described and defined in any aspects of the disclosure can be implemented and/or supplied and/or used independently.

As used throughout, the word ‘or’ can be interpreted in the exclusive and/or inclusive sense, unless otherwise specified.

### BRIEF DESCRIPTION OF THE DRAWINGS

The disclosure extends to an apparatus, a system and a method as described herein and/or substantially as illustrated with reference to the accompanying drawings. The present disclosure is now described, purely by way of example, with reference to the accompanying diagrammatic drawings, in which:

FIG. 1 shows a shows an exemplary fiber optic telecommunications network.

FIG. 2 shows a diagnostics apparatus as used in the fiber optic telecommunications network.

FIG. 3 shows an exemplary reflectivity response of the diagnostics apparatus.

FIG. 4 is a process of operating the fiber optic telecommunications network.

FIG. 5 is a comparison of diagnostics results retrieved according to the aforementioned process.

### DETAILED DESCRIPTION

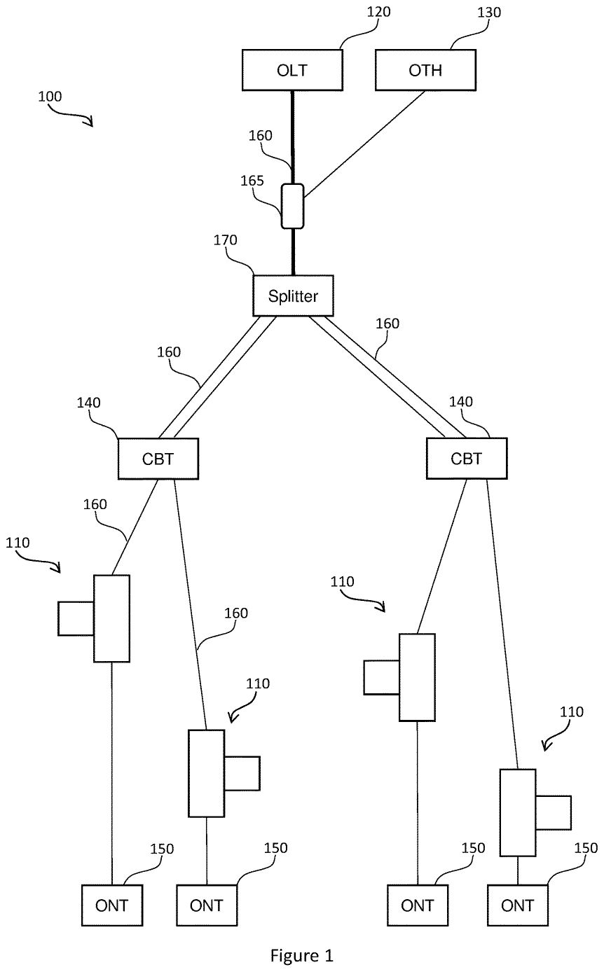

FIG. 1 shows a fiber optic telecommunications network 100 comprising a/an: diagnostics apparatus 110; optical receiver and transmitter 120 in the form of an Optical Line Termination (OLT); Optical Test Head (OTH) 130; plurality of Connectorized Block Terminals (CBTs) 140; plurality of Optical Network Terminals (ONTs) 150; network of fiber optic cables 160; a Wave Division Multiplexer (WDM) 165; and splitter 170. The telecommunications network is in the form of a point-to-multipoint Passive Optical Network (PON), such as for providing large-scale fixed-access broadband services.

The OLT 120 and OTH 130 are located at the head-end of the access network, for example where a local exchange or a central office is sited. The OLT and splitter 170 are connected by the network of fiber optic cables 160, and specifically via a spine fiber, and via the WDM 165; the OTH 130 is also connected to the splitter 170 via the WDM 165.

The OLT 120 is operatively connected to a higher-layer network management software application comprising an Element Management System (EMS) and/or a Network Management System (NMS), which, for brevity, are not shown. The OLT is configured to transmit and receive service signals through the network of fiber optic cables 160 to customer premises at each ONT 150, thereby to provide a telecommunications service.

The OTH 130 comprises an optical reflectometry sensor in the form of an Optical Time Domain Reflectometer (OTDR) for transmitting diagnostic signals through the network of fiber optic cables 160, towards the plurality of ONTs 150, and for measuring received reflections, at least, therefrom.

In the example of FIG. 1, the optical splitter 170 is connected, via the network of fiber optic cables 160, and specifically a primary distribution network, to two CBTs 140. In turn, each CBT 140 is connected to two ONTs 150 via the network of fiber optic cables 160, and specifically via a secondary distribution network.

It will be appreciated that the fiber optic telecommunications network 100 shown in FIG. 1 is purely exemplary, and is available to differ in various aspects, as will be appreciated within the field of telecommunications.

In this example, the diagnostics apparatus 110 is provided at a fiber optic cable of each limb of the secondary distribution fiber optic network connecting the CBTs 140 to the ONTs 150.

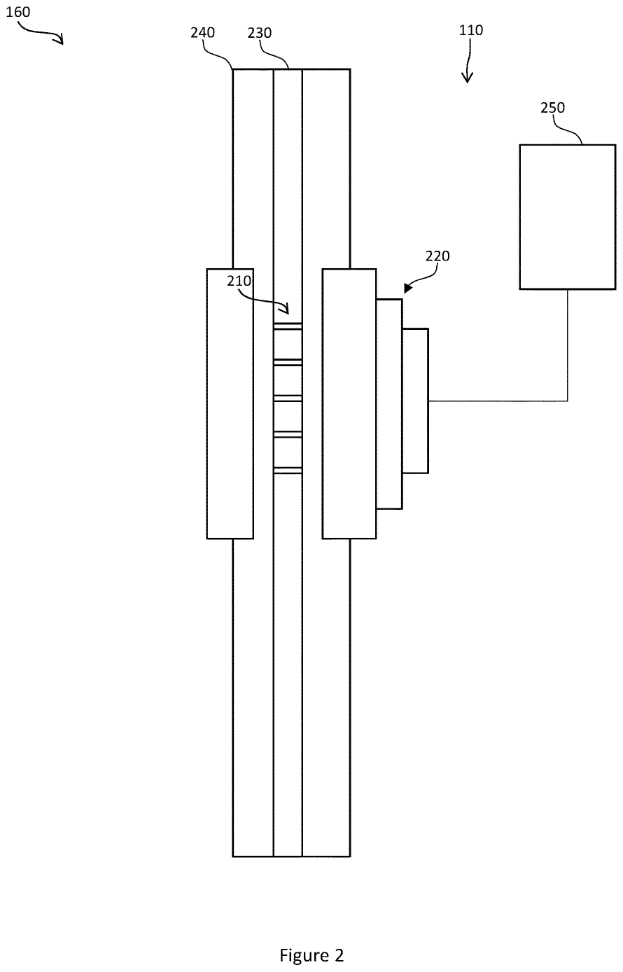

As shown in more detail in FIG. 2, the diagnostics apparatus 110 comprises a/an: reflective element 210; and adjustor 220 for adjusting a state of the reflective element.

The reflective element 210 is configured to have variable reflectivity as a function of wavelength and a parameter controllable by the adjustor 220. The parameter is available to be: temperature; angle relative to incident light; current or voltage; force; and/or form (e.g. shape and/or dimensions). The adjustor is configured to manipulate the reflective element, in a controllable, known, reversible, non-destructive, and repeatable manner so as to adjust the parameter, and in turn the reflectivity of the reflective element at a given wavelength.

In the specific example of FIG. 2, the reflective element 210 is in the form of a temperature-adjustable grating, and specifically a Bragg grating, and yet more specifically a fiber Bragg grating. The fiber Bragg grating is provided within a core 230 of a fiber optic cable of the network of fiber optic cables 160. The fiber Bragg grating provides a reflectivity response that is wavelength-and temperature-dependent. At a given temperature, peak reflectivity occurs at a specific wavelength to which the grating is tuned, as associated with the Bragg wavelength of the grating. Reflectivity generally decreases for wavelengths away from the Bragg wavelength. As temperature increases, however, so does the Bragg wavelength of the grating; this shifts the entire reflectivity response of the grating such that the Bragg wavelength increases, and in turn as does the wavelength at which peak reflectivity occurs.

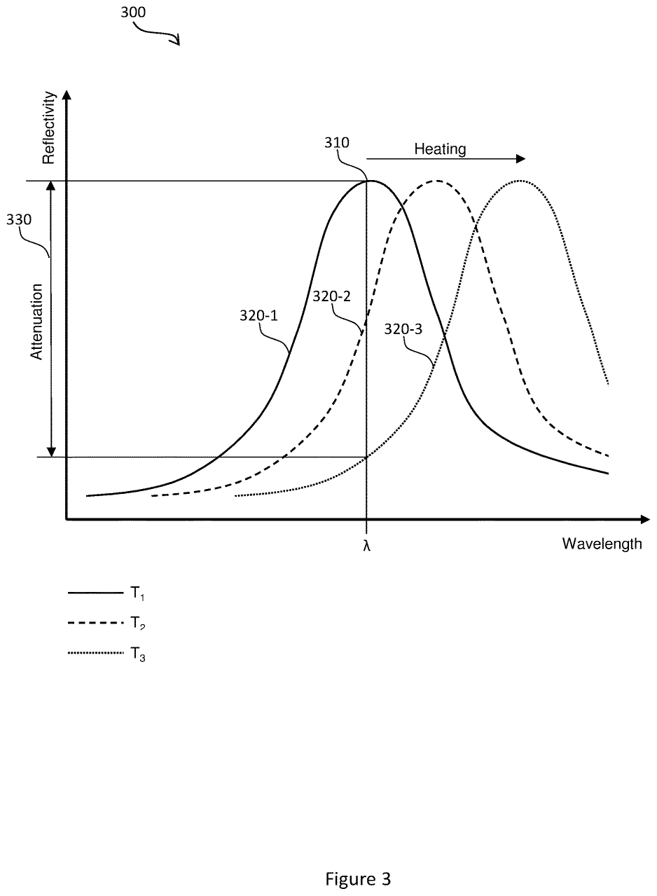

To help illustrate this temperature-dependent reflectivity-shifting effect, FIG. 3 schematically illustrates reflectivity responses 300 of the reflective element 210 as a function of wavelength and at different temperatures of the reflective element.

At a first temperature, T₁, peak reflectivity 310, and the reflective response 320-1 (shown as a solid line) is centered upon, a specific wavelength, A. When the fiber Bragg grating is heated to a higher temperature, T₂, the specific wavelength at which peak reflectivity occurs also increases, and the reflectivity response 320-2 (shown using a dashed line) shifts accordingly. At a still higher temperature, T₃, than T₂, the specific wavelength at which peak reflectivity occurs increases further, and the reflectivity response 320-3 (shown using a dotted line) shifts further. Therefore, reflectivity at A is lower at T₃ than at T₂, which is in turn lower at T₂ than at T₁; in this way, for a constant wavelength (e.g. A), varying temperature of the temperature-adjustable grating also adjusts reflectivity. Reflections of light at wavelength A can therefore be attenuated 330 by heating the temperature-adjustable grating from T₁ to T₂, and, further still, to T₃. Typically, an appropriate value of T₁ may be set around ambient environmental temperatures (e.g. −20° C. to 40° C.), T₂ to around 75° C. to 150° C., and T₃ to around 200° C. to 300° C.

Referring back to FIG. 2, to control reflectivity of the fiber Bragg grating, the adjustor 220 is in the form of a heater, and specifically a Thermo-Electric Heat Pump (having two-stage form in FIG. 2), also referred to as a Thermo-Electric Cooler (TEC). The heater is provided around sheathing 240 of the fiber core 230 at the location of the fiber Bragg grating. The heater is connected to a controller 250 for triggering, sensing and energizing the heater, for example in the form of a switch or processor, thermal sensor, and battery, respectively. The controller 250 is available to be operated directly by a user, or remotely activated, for example by the OTH 130. To help improve thermal conductivity, and therefore a rate of adjustment of the parameter (i.e. temperature), and therefore reflectivity of the reflective element, the sheathing 240 is thinner, and/or formed of a thermal conductor, at the location directly surrounding the fiber Bragg grating, than that adjacent the fiber Bragg grating.

As described in more detail below, the diagnostics apparatus 110, in interaction with the OTH 130, is configured to exploit a controllable reflectivity effect in a manner that allows for testing of the fiber optic network 100, and in particular to help reconcile the physical location of the diagnostics apparatus with sensed diagnostic information from the OTH.

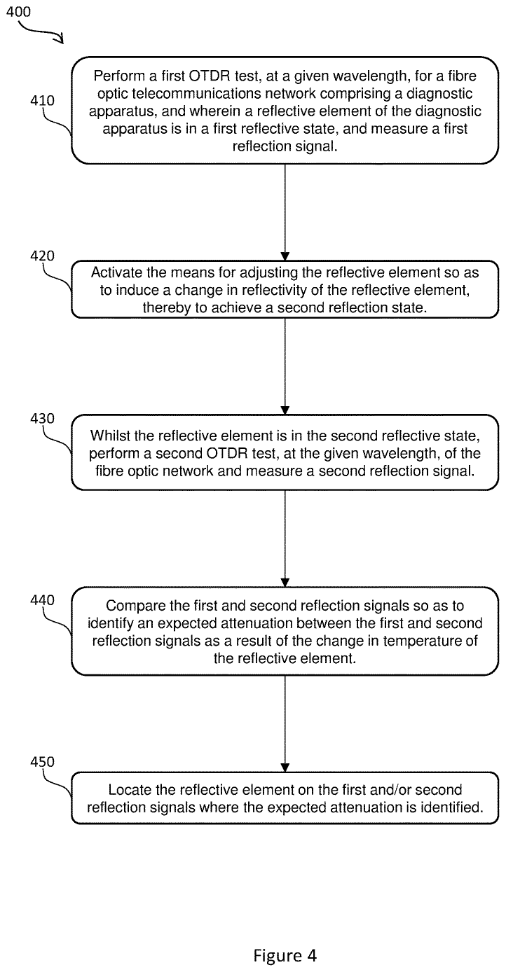

FIG. 4 shows a process 400 of operating the fiber optic telecommunications network 100.

At 410, a first OTDR test is performed using the OTH (specifically, the constituent OTDR) by injecting a diagnostic signal at a known wavelength, A, through a portion of the fiber optic network comprising the reflective element 210; this test is performed whilst the reflective element is in a first reflective state. The OTH measures reflected signals thereby to generate a first reflection result, which is in the form of a first OTDR trace. The first OTDR trace is a ‘baseline’ result used for later comparison.

In one example, the first reflective state is a default state of the reflective element 210, or a state governed by ambient conditions in the environment of the reflective element, such as ambient temperature, rather than through operation or energization of the adjustor. In one example, the first reflective state is that which achieves, at the wavelength at which the first OTDR test is performed, peak (or near-peak) reflectivity, which is a reflectivity of at least 90%.

At 420, the diagnostics apparatus 110 is operated so that the adjustor 220 induces a change in the parameter and therefore a change in the reflectivity of the reflective element 210 from the first reflective state to a second reflective state. The extent of the change in the parameter is selected to induce a significant (that is, detectable, by the OTH) change in reflectivity. The reflectivity in the reflective state is lower than in the first reflective state.

Where the reflective element 210 has a temperature-dependent reflectivity, and where the adjustor 220 is a heater, at 420, the heater is activated to heat the reflective element to a predetermined temperature that achieves the second reflective state (based, for example, on a pre-known calibrated temperature response). With reference to FIG. 3, the first reflective state achieves a reflectivity, at A, governed by the reflectivity response at T₁ 320-1, whereas the second reflective state archives a reflectivity, also at A, governed by the reflectivity response at T₂ 320-2 (or, for greater effect, at T₃ 320-3). Since reflectivity in the second reflective state has significantly reduced, an intensity of reflections from the reflective element 210 can be expected to decrease compared to reflections when then reflective element is in the first reflective state.

At 430, whilst the reflective element 210 is in the second reflective state, a second OTDR test is performed by the OTH 130 in a corresponding manner to the first OTDR test (i.e. using, within tolerances of uncertainty, the same wavelength, A). The OTH then measures the reflected signals, thereby to generate a second reflection result in the form of a second OTDR trace.

In one example, the processing at 430 is performed in response to determining, or estimating, that the reflective element 210 is in the second reflective state; this is achieved by:
directly measuring the controllable parameter (and having knowledge of the parameter-based reflectivity response, for example through prior calibration), for example using the thermal sensor where the controllable parameter is temperature; directly measuring reflectivity of the reflective element, for example from an OTDR test; and/or by waiting a pre-determined elapsed time. A feedback loop is provided between the diagnostics apparatus 110, and specifically the controller 250, and the OTH 130 to trigger the second OTDR test in this way.

At 440, the first and second OTDR traces are compared to each other. The comparison comprises identifying significant (i.e. in excess of a threshold tolerance) and expected (i.e. corresponding to the known, or estimated, magnitude and direction of change in reflectivity between the first and second reflective states) differences in measured reflection intensities at comparable points; where such differences are identified, the location of the reflective element 210 within the first and second OTDR traces can therefore be identified and tagged at 450. In this way, the fiber optic cable within which the reflective element is provided may also be identified.

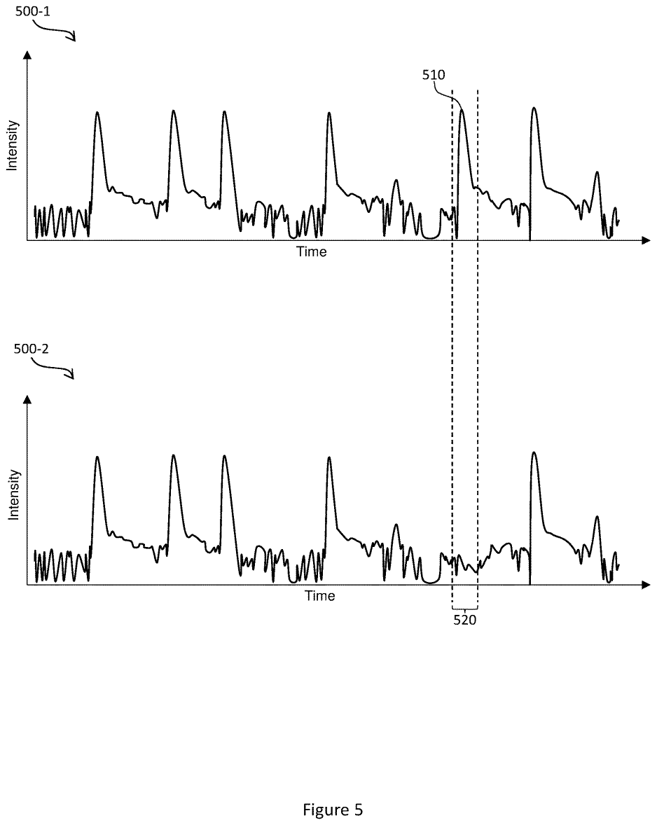

To help illustrate the processing performed at 440 and 450, FIG. 5 shows exemplary schematic first 500-1 and second 500-2 OTDR traces obtained as per 410 and 430, respectively, and where reflectivity in the second reflective state is significantly lower than in first reflective state. As can be seen, the second reflection result 500-2 only differs from the first reflection result 500-1 in that a reflection 510 present in the second reflection result 500-2 effectively disappears (below a noise floor). Since the attenuation is of a magnitude and direction that is to be expected from a change from the first to the second reflective states, disappearance of the reflection 510 is reasonably attributed to the presence and intentional manipulation of the reflective element 210 by the adjustor 220. Accordingly, this therefore indicates that the reflective element 110 is located at a point 520 corresponding to where the expected attenuation of the reflection 510 occurs; the reflective element 210 is therefore tagged at this point in the OTDR traces.

By performing process 400 using only one of the diagnostics apparatus 110 at a time and sequentially for each diagnostics apparatus 110, each of the fiber optic cables of the secondary distribution networks can be identified.

### Alternatives and Modifications

The reflective element 210 is, for example, a grating having a grating period dependent upon any aforementioned parameter.

In particular, where the parameter is orientation, the adjustor is, for example, an actuator for rotating the reflective element such that an apparent grating period is variable with angle. Where the parameter is current or voltage, the reflective element is configured to exhibit a piezoelectric effect, and the adjustor is, for example, an electric circuit for inducing a physical change in the grating period using electric charge. Where the parameter is current or voltage, the reflective element is deformable, and the adjustor is, for example, a mechanism for applying a force so as to induce a physical change in (e.g. stretching of) the grating period.

In an alternative, the reflective element 210 is available to be a reflector, such as a thin film reflector or a dielectric mirror. For example, the parameter may be current or voltage, and the reflective element is configured to exhibit electro-reflectance, and the adjustor is, for example, an electric circuit for inducing a change in reflectivity using an electric field.

In an alternative, rather than being integrally formed as part of the fiber optic network, the diagnostics apparatus 110 is a standalone device for fitment into the fiber optic network, temporarily or permanently. To do so, the diagnostics apparatus further comprises an optical connector for optically connecting the reflective element 210 to the fiber optic network so as to intercept and then reflect a diagnostics signal from the OTH. The diagnostics apparatus is configured to be installed at any point within the fiber optic network, and in particular at, or proximate to, the ONTs 150, CBTs 140 or splitter 170.

To help improve the confidence that the expected change in reflectivity is as a direct and sole result of the induced change from the first to the second reflective statuses, process 400 is available to be repeated using the same diagnostics apparatus 110, and a plurality of first and second reflection results compiled, compared and averaged, as appropriate. That is, the diagnostics apparatus 110 can be “flashed” between the first and second reflective states whilst conducting multiple OTDR tests.

In yet another alternative, the adjustor 220 is operated to induce in the reflective element 210 at least one further reflective status, different to the first and second reflective statuses, and an OTDR test is performed whilst the reflective element is in each at least one further reflective statuses; the ensuing results are compared in a corresponding manner to 450. In this way, stepped changes can be made to the reflectivity of the reflectivity element to help increase confidence of causality.

It will be appreciated that to help identify the reflective element 210 across changes in OTDR tests, merely an expected and detectable relative change in reflection intensities is required between the first and second OTDR tests, and therefore any reflectivity values for first and second reflective states may be selected. It will be appreciated that errors in measurements and configuration (such as consistent wavelengths in the diagnostics signals) may be reduced by increasing the difference in reflectivity, and process 400 rendered more time-and resource-efficient by the first reflective state being governed by a default or ambient state of the reflective element.

In an alternative, the OTH 130 comprises an Optical Frequency-Domain Reflectometer, and is therefore configured to perform an OFDR test process at 410 and 430. An OFDR test uses a continuous wave signal that allows for a higher signal-to-noise ratio than OTDR, and therefore allows for more accurate measurements to be taken. However, OFDR relies upon a frequency sweep (rather than an optical pulse at a given wavelength). Since reflectivity of the reflective element varies with wavelength, to identify the reflective element 210, the adjustor 220 is operated so as to vary reflectivity of the reflective element in a manner indicative, in an OFDR trace, of controlled and recognizable intervention.

For example, the adjustor 220 is used to vary the parameter so as to maintain, across the frequency sweep of an OFDR test, substantially constant reflectivity; to do so, the adjustor is provided with information as to the characteristics of the OFDR frequency sweep (i.e. sweep rate and wavelengths), thereby to determine a target value of the parameter for the reflective element that, at the appropriate times and wavelengths, maintain constant reflectivity. To help achieve synchronization between the adjustor 220 and the OFDR, the adjustor is in communication with the OTH 130 via the controller 250. In another example, the adjustor is used to vary the parameter so as to vary reflectivity across the frequency sweep of the OFDR in a pre-determined manner without maintaining constant reflectivity at a given wavelength of the OFDR sweep.

In an alternative, the reflectivity response of the reflective element is only a function of the parameter, and is effectively constant across a broad range of wavelengths.

Each feature disclosed herein, and (where appropriate) as part of the claims and drawings may be provided independently or in any appropriate combination.

Any reference numerals appearing in the claims are for illustration only and shall not limit the scope of the claims.

1. A system for testing a fiber optic network, comprising:
an apparatus comprising:
a reflective element for intercepting a light transmission transmitted along a fiber optic cable of the fiber optic network, the reflective element having a parameter-based variable reflectivity response, and
an adjustor for adjusting the parameter associated with the reflective element, thereby to change, at a wavelength of the light transmission, reflectivity of the reflective element thereby selectively to change between a first reflectivity and a second reflectivity;
an optical source for transmitting the light transmission through the fiber optic cable to the reflective element; and
an optical reflectometry sensor for detecting a reflection of the light transmission through the fiber optic cable from the reflective element.

2. The system according to claim 1, wherein the parameter is temperature, and wherein the adjustor is at least one of a heater or a cooler configured to change a temperature of the reflective element.

3. The system according to claim 1, wherein the apparatus is provided away from the optical source and the optical reflectometry sensor.

4. The system according to claim 1, wherein the apparatus is formed as a part of at least one of a splitter; a through-connector; an end reflector; an Optical Network Terminal (ONT); a coupler; or a Wavelength-Division Multiplexer.

5. The system according to claim 1, wherein the apparatus further comprises a receiver for receiving a transmitted instruction, from the optical source, for controlling the adjustor so as to achieve the first reflectivity or the second reflectivity.

6. The system according to claim 1, wherein at least one of the optical source or the optical reflectometry sensor forms part of an Optical Time-Domain Reflectivity apparatus or an Optical Frequency-Domain Reflectivity apparatus.

7. The system according to claim 1, wherein:
the reflective element is provided within the fiber optic cable, or wherein
the apparatus further comprises an optical connector for connecting the reflective element to the fiber optic cable,
thereby to intercept and reflect the light transmission.

8. The system according to claim 1, wherein the reflective element comprises an optical grating.

9. The system according to claim 1, wherein the light transmission is a diagnostic test signal.

10. The system according to claim 1, wherein at least one of the first reflectivity or and/or the second reflectivity is substantially transparent to a service signal transmitted at a service wavelength.

11. The system according to claim 1, further comprising a sensor for at least one of detecting a state of the adjustor or and/or for measuring the parameter as associated with the reflective element.

12. The system according to claim 1, wherein the fiber optic network is in the form of a point-to-multipoint Passive Optical Network (PON).

13. The system according to claim 1 wherein the apparatus is arranged at, or proximate to, an Optical Network Terminal (ONT), a Connectorized Block Terminal (CBT), or a splitter of the fiber optic network.

14. The method of testing a fiber optic network, the network comprising an apparatus comprising a reflective element for intercepting a light transmission transmitted along a fiber optic cable of the fiber optic network, the reflective element having a parameter-based variable reflectivity response, and an adjustor for adjusting the parameter associated with the reflective element, thereby to change, at a wavelength of the light transmission, reflectivity of the reflective element thereby selectively to change between a first reflectivity and a second reflectivity; an optical source for transmitting the light transmission through the fiber optic cable to the reflective element; and an optical reflectometry sensor for detecting a reflection of the light transmission through the fiber optic cable from the reflective element, the method comprising:
retrieving, from the optical reflectometry sensor:
a first reflection result for a first test performed using the light transmission transmitted by the optical source through the fiber optic cable to the reflective element while the reflective element is configured to have the first reflectivity, and
a second reflection result for a second test performed using the light transmission transmitted by the optical source through the fiber optic cable to the reflective element while the reflective element is configured to have the second reflectivity, as achieved by using the adjustor;
comparing the first reflection result and the second reflection result;
identifying an expected change between the first reflection result and the second reflection result, as a consequence of changing between the first reflectivity and the second reflectivity; and
locating the reflective element on the first reflection result or the second reflection result where the expected change is identified.

15. The method according to claim 14, wherein the expected change is an expected attenuation.

16. The method according to claim 14, wherein the optical reflectometry sensor is an Optical Time-Domain Reflectometer.

17. The method according to claim 14, wherein: the optical reflectometry sensor is an Optical Frequency-Domain Reflectometer (OFDR); the first reflectivity and the second reflectivity are equal; the adjustor is operated to maintain a constant reflectivity; and the expected change is therefore an expected constancy.

18. The method according to claim 14, wherein a time period between the first test and the second test is known, and wherein the adjustor is operated to switch between the first reflectivity and the second reflectivity with a frequency equal, or corresponding to, the known time period.

19. The method according to claim 14, wherein the adjustor is remotely operated by at least one of the optical source or and/or the optical reflectometry sensor.

20. A non-transitory computer-readable carrier medium comprising a computer program, which, when the computer program is executed by a computer, causes the computer to carry out the, one method of claim 14.

21. An apparatus for use in testing a fiber optic network, comprising:
a reflective element for intercepting a light transmission transmitted along a fiber optic cable of the fiber optic network, the reflective element having a parameter-based variable reflectivity response; and
an adjustor for adjusting the parameter associated with the reflective element, thereby to change, at a wavelength of the light transmission, reflectivity of the reflective element thereby selectively to change between a first reflectivity and a second reflectivity.
